(19) United States
(12) Patent Application Publication
(10) Pub. No.: US 2013/0116055 A1
(43) Pub. Date: May 9, 2013

(54) CONSTANT-VELOCITY TRIPOD JOINT

(71) Applicants: Christophe Walliser, Haguenau (FR); Remy Bernhardt, Haguenau (FR)

(72) Inventors: Christophe Walliser, Haguenau (FR); Remy Bernhardt, Haguenau (FR)

(73) Assignee: Schaeffler Technologies Ag & Co., KG, Herzogenaurach (DE)

(21) Appl. No.: 13/810,717

(22) PCT Filed: Jun. 15, 2011
(86) PCT No.: PCT/EP11/59900

§ 371 Date: Jan. 17, 2013

(30) Foreign Application Priority Data
Jul. 21, 2010 (DE) 102010031752.7

(51) Int. Cl. F16D 3/24

(52) U.S. Cl. CPC F16D 3/24
USPC 464/111

(57) ABSTRACT

A constant-velocity tripod joint having an outer joint part having a central cavity and three recesses extending out therefrom. Two axially parallel slideways are disposed in mutual parallel opposition around the inner periphery. An inner joint part within the cavity of the outer joint part, and three trunnions having a spherical outer contour configured so as to be uniformly distributed around the inner periphery and to each extend radially into one of the recesses of the outer joint part. Each of three tripod rollers have an inner roller ring, an outer roller ring, and a plurality of cylindrical rolling bodies disposed annularly between the roller rings the respective inner roller rings being disposed, in each case by the inner wall thereof, in sliding contact with the outer contour of the associated trunnion; and the respective outer roller rings being disposed, in sliding contact with the slideways of the associated recess.

### FIELD OF THE INVENTION

The present invention relates to a constant-velocity tripod joint having an outer joint part which has a central cavity and three recesses extending out therefrom and configured so as to be uniformly distributed around the inner periphery, each having two axially parallel slideways disposed in mutual parallel opposition around the inner periphery; having an inner joint part configured within the cavity of the outer joint part, and three trunnions having a spherical outer contour and configured so as to be uniformly distributed around the inner periphery and to each extend radially into one of the recesses of the outer joint part; and having three tripod rollers, each having an inner roller ring, an outer roller ring, and a plurality of cylindrical rolling bodies disposed annularly between the roller rings; and the respective inner roller rings being disposed, in each case by the inner wall thereof, in sliding contact with the outer contour of the associated trunnion; and the respective outer roller rings being disposed, in each case by the outer wall thereof, in sliding contact with the slideways of the associated recess.

### BACKGROUND

In the axle drive of motor vehicles, the output shafts of the axle differential and the wheel hubs of the driven wheels are operatively interconnected by a jointed shaft. The two jointed shafts are provided at each of the two ends thereof with a constant-velocity joint, which, by transmitting a uniform rotary motion, makes possible the substantially vertical compression and rebound of the wheel suspensions and, in the case of a steerable vehicle axle, additionally the steering-dependent rotation of the steering knuckle about a substantially vertical steering axle, respectively allows for compensation of the corresponding movements. In the case of a steerable vehicle axle, such as the front axle of a front-wheel-drive or all-wheel-drive motor vehicle, the suspension- and steering-dependent movement of the wheel hubs is quite substantial, thereby necessitating a large joint angle for the outer constant-velocity joints of the particular axle drive shafts. Besides the type of double joint design, where two universal joints are combined to form one joint, and the type of ball joint design, where, for the most part, at least six balls supported on a ball star are guided in associated ball races of a ball socket, the especially compact design of the constant-velocity tripod joint having a large joint angle is preferred for the outer constant-velocity joints of steerable drive axles.

A constant-velocity tripod joint normally has an outer joint part having a central cavity and three recesses extending out therefrom that are configured so as to be uniformly distributed around the inner periphery, each having two axially parallel slideways disposed in mutual parallel opposition around the inner periphery, as well as an inner joint part that is configured within the cavity of the outer joint part, and three trunnions having a spherical outer contour and configured so as to be uniformly distributed around the inner periphery and to each extend radially into one of the recesses of the outer joint part. Mounted on each of the trunnions of the inner joint part is a tripod roller having an inner roller ring, an outer roller ring, and a plurality of cylindrical rolling bodies disposed between the roller rings; relative to the middle axis of the particular trunnion, the cylindrical inner wall of the inner roller ring being disposed in sliding contact with the outer contour of the associated trunnion so as to be axially displaceable and pivotable relative thereto; and, relative to the rotational axis of the outer joint part, the cylindrical outer wall of the outer roller ring being disposed in sliding contact with the slideways of the associated recess so as to be axially displaceable relative thereto. Thus, the sliding movement between the outer contours of the trunnions of the inner joint part and the inner walls of the inner roller rings essentially allows the suspension- and steering-dependent pivoting of the axes of rotation of the inner joint part and of the outer joint part, whereas the sliding movement between the outer walls of the outer roller rings and the slideways of the recesses of the outer joint part makes possible the required linear compensation.

The German Patent DE 44 29 479 C2 describes two variants of a first constant-velocity tripod joint. In the case of the tripod rollers of this known constant-velocity tripod joint, the inner roller rings and the cylindrical rolling bodies are each guided axially on both sides by shared retaining rings inserted in corresponding annular grooves of the outer roller rings. In the case of this constant-velocity joint, the advantage of simple manufacturing, in particular, of the outer roller ring, is countered by the disadvantages of a more difficult assembly of the correspondingly large and rigidly dimensioned retaining rings, as well as of the comparatively poor noise and vibration properties (NVH=noise vibration harshness).

The German Patent Application DE 198 34 513 A1 discusses multiple variants of a second constant-velocity tripod joint of this kind. In the case of the tripod rollers of this known constant-velocity tripod joint, the outer roller rings, on the radial inner side thereof, each include a graduated bearing collar disposed axially on both sides, of which the axially inner collar sections of the axial guide of the cylindrical rolling bodies and the axially outer collar sections are used in conjunction with the retaining rings inserted axially on both sides for axially guiding the inner roller ring. In the case of this constant-velocity joint, the disadvantage of the more expensive manufacturing, in particular, of the outer roller rings, is countered by the advantages of a simplified assembly of the relatively small retaining rings having a soft-spring design, as well as of the reduced friction level within the tripod rollers and of the improved noise and vibration properties (NVH).

However, to meet the continually increasing requirements for comfort, there is a further need to improve the noise and vibration properties of the constant-velocity tripod joint that are largely determined by the transitions between static friction and sliding friction at the walls of the constant-velocity joint components that are disposed in mutual sliding contact. Moreover, to increase transmission efficiency, there is a general need to reduce the friction and wear these types of constant-velocity joints are subject to.

### SUMMARY OF THE INVENTION

It is an object of the present invention to provide an improved design of a constant-velocity tripod joint of the type mentioned at the outset, particularly with regard to improving the noise and vibration properties and to reducing the level of friction and wear.

It is an underlying realization of the present invention that improving the noise and vibration properties of a constant-velocity tripod joint goes hand in hand with reducing the level of friction and wear of the same since the vibrations generated and excited within the constant-velocity joint and perceived as vibrations and as noise are essentially determined by the transition between static and sliding friction at the walls of the constant-velocity joint components that are disposed in mutual sliding contact. Reducing the internal friction, i.e., the friction among the components of the constant-velocity joint, not only reduces the friction-induced wear, but also positively influences the noise and vibration properties of the constant-velocity joint, i.e., the vibration and noise phenomena occurring during vehicle operation.

The present invention provides that the frictional and wear properties of the constant-velocity joint are improved by a suitable surface treatment, in particular, of each of the walls that are disposed in sliding contact with another component.

The friction occurring between the particular walls as a function of the operating conditions and, thus, the friction-induced wear at both of the walls is reduced by providing an appropriate surface treatment for at least one wall that is disposed in sliding contact with another wall, At the same time, the force level at which the transition from static to sliding friction and back takes place, is lowered, whereby the amplitude of the vibrations produced by the frictional transition and, thus, the vibrations and noise emissions produced by the same is/are significantly reduced. In comparison to previous designs, the surface treatment may, in fact, increase the cost of manufacturing the constant-velocity tripod joint. However, this is countered by the advantages of a greater running smoothness and prolonged lifetime of the constant-velocity tripod joint according to the present invention.

For the surface treatment, it is preferably provided that at least the inner roller rings and/or the outer roller rings and/or the retaining rings used for axially securing the roller rings be provided with an anti-friction coating. To simplify handling, the components in question are completely provided with the anti-friction coating, even when the friction and wear-reducing effect is largely limited to those walls that are disposed in sliding contact with the wall of another component, respectively.

The anti-friction coating of the inner roller rings and/or of the outer roller rings and/or of the retaining rings is advantageously applied by a coating-forming phosphating treatment since a correspondingly galvanically produced phosphate coating is particularly thin, and, thus, the dimensions of the components in question do not change appreciably, and the surface roughness of the surfaces in question increases only slightly. In addition, due to its crystalline constitution and microcapillary surface structure, a phosphate coating has good storage properties for lubricants, such as oil or fat.

The anti-friction coating of the inner roller rings and/or of the outer roller rings and/or of the retaining rings is preferably in the form of a manganese phosphate coating having a thickness of 2 to 6 μm, which, in comparison to other phosphate coatings, such as iron phosphate or zinc phosphate coatings, features better friction and wear properties.

Another type of surface treatment, which may be used alternatively or additionally to the anti-friction coating, provides for slide grinding the inner roller rings, at least at the inner and end-face walls thereof, and/or the outer roller rings, at least at the outer walls thereof, and/or the retaining rings, at least at the inner walls thereof facing the end-face walls of the inner roller rings. If slide grinding is additionally used, it is carried out prior to application of the anti-friction coating.

The slide grinding process makes it possible to reduce the surface roughness of the inner and end-face walls of the inner roller rings and/or of the inner walls of the retaining rings to a value of approximately Ra=0.2 μm and, thus, to approximately halve the surface roughness of approximately Ra=0.45 μm that is customary in known methods heretofore.

The surface roughness of the outer walls of the outer roller rings may be reduced by the slide grinding process to a value of approximately Ra=0.45 μm, which, in comparison to the value of Ra=1.0 μm obtained in a customary processing of known methods, likewise corresponds approximately to a halving of the value.

To further lower the resistance to movement of the constant-velocity joint, it may additionally be provided to reduce the rolling resistance between the roller rings and the rolling bodies of the tripod rollers in each case by providing a finish-ground surface for the outer raceway of the inner roller ring, for the inner raceway of the outer roller ring, and for the outer wall of the rolling bodies, and to reduce the radial play between the roller rings and the rolling bodies.

To this end, the surface roughness of the outer raceway of the inner roller ring, of the inner raceway of the outer roller ring, and of the outer wall of the rolling bodies may be reduced in each case to a value within the range of between Ra=0.2 μm and Ra=0.45 μm, and the radial play between the roller rings and the rolling bodies to a value within the range of between s_{R}=0.008 mm and s_{R}=0.030 mm, which, in comparison to a customary processing-machining of known methods, corresponds to approximately a halving of surface roughness Ra and an approximately 30% reduction in radial play s_{R}.

### BRIEF DESCRIPTION OF THE DRAWINGS

The present invention is explained in greater detail below in light of the accompanying drawing and with reference to a preferred specific embodiment. The individual figures show:

FIG. 1 an enlarged detail of the tripod roller according to FIG. 2;

FIG. 2 a tripod roller of the constant-velocity tripod joint according to FIG. 3 in a cross section; and

FIG. 3 a constant-velocity tripod joint in a radial cross section.

### DETAILED DESCRIPTION

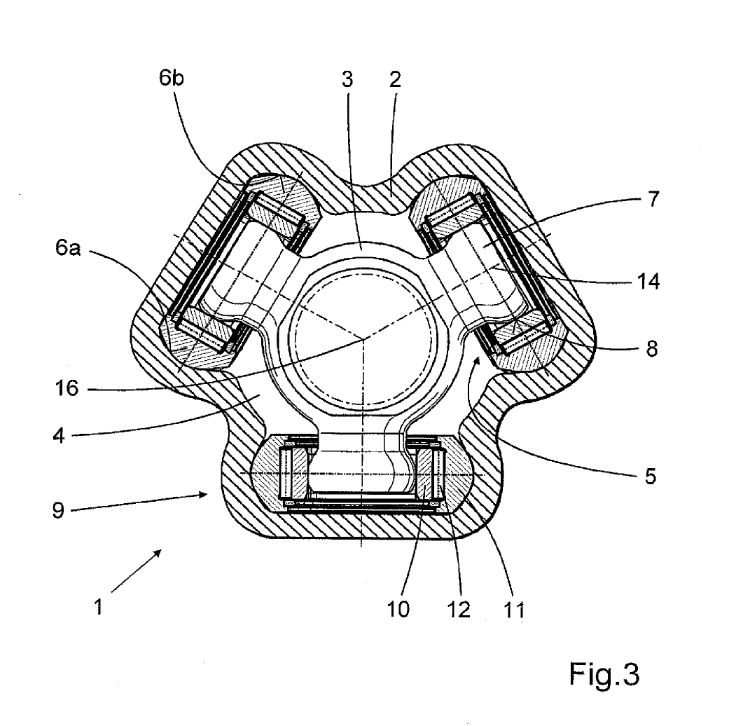

A constant-velocity tripod joint I illustrated in FIG. 3 has an outer joint part 2, which has a central cavity 4 and three recesses 5 extending out therefrom and configured so as to be uniformly distributed around the inner periphery, each having two axially parallel slideways 6a, 6b disposed in mutual parallel opposition around the inner periphery, as well as an inner joint part 3 that is configured within cavity 4 of outer joint part 2, and having three trunnions 7 having a spherical outer contour 8 and configured so as to be uniformly distributed around the inner periphery and to each extend radially into one of recesses 5 of outer joint part 2.

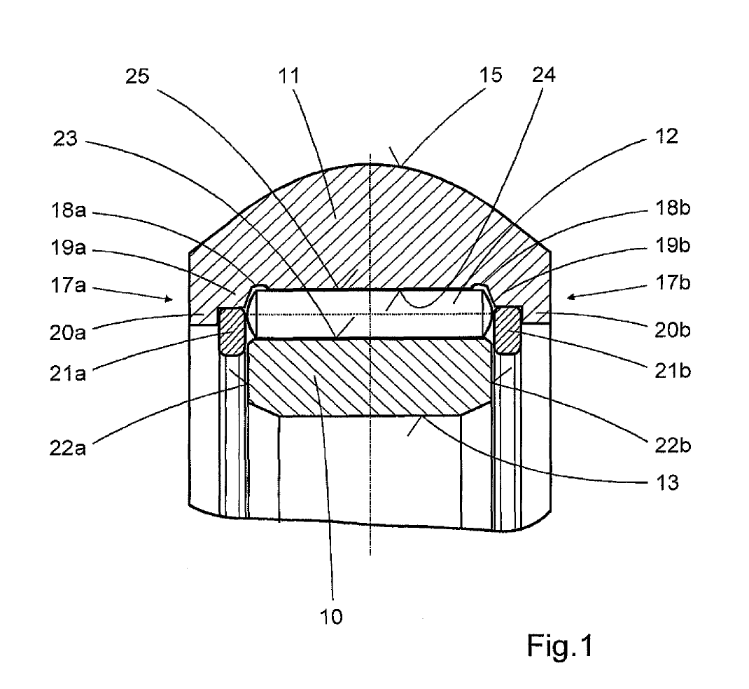

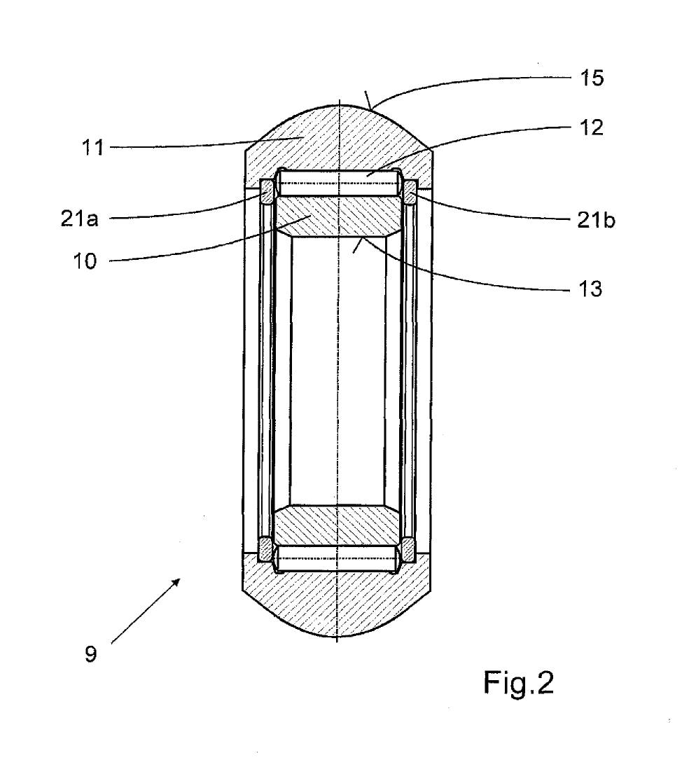

Configured on each of trunnions 7 of inner joint part 3 is a tripod roller 9, as shown separately in FIG. 2 and in FIG. 1 in an enlarged detail. It has an inner roller ring 10, an outer roller ring 11, and a plurality of cylindrical rolling bodies 12 placed between roller rings 10, 11. Relative to middle axis 14 of trunnion 7 in question, cylindrical inner wall 13 of inner roller ring 10 is disposed in sliding contact with outer contour 8 of associated trunnion 7 so as to be axially displaceable and pivotable relative thereto. Relative to rotational axis 16 of outer joint part 2, cylindrical outer wall 15 of outer roller ring 11 is disposed in sliding contact with slideways 6a, 6b of associated recess 5 axially displaceably relative thereto.

On the radial inner side thereof, outer roller rings 11 of tripod rollers 9 each feature a graduated bearing collar 17a, 17b axially on both sides, of which axially inner collar sections 19a, 19b, which are each provided with a relief 18a, 18b, are used for axially guiding cylindrical rolling bodies 12, and axially outer collar sections 20a, 20b are used in conjunction with retaining rings 21a, 21b that are inserted axially on both sides to axially guide inner roller ring 3.

In accordance with the present invention, the frictional and wear properties of constant-velocity joint 1 are improved by providing a suitable surface treatment, in particular of walls 8, 13; 6a, 6b, 15 that are each disposed in sliding contact with another component.

Specifically, in the present application example, it is provided for this purpose that outer roller rings 11 of tripod rollers 9 be provided with an anti-friction coating in the form of a manganese phosphate coating having a thickness of 2 to 6 μm, and that inner roller rings 10 of tripod rollers 9 undergo slide grinding at inner and end-face walls 13, 22a, 22b thereof to a surface roughness of approximately Ra=0.2 μm. Moreover, the rolling resistance between roller rings 10, 11 and rolling bodies 12 of tripod rollers 9 is reduced in each case by providing a finish-ground surface for outer cylindrical raceway 23 of inner roller ring 10, for inner cylindrical raceway 24 of outer roller ring 11, and for outer wall 25 of rolling bodies 12, as well as by reducing the radial play between roller rings 10, 11 and rolling bodies 12.

### LIST OF REFERENCE NUMERALS

1 constant-velocity tripod joint
2 outer joint part
3 inner joint part
4 cavity
5 recess
6a, 6b slideway
7 trunnion
8 outer contour of trunnion 7
9 tripod roller
10 inner roller ring, roller ring
11 outer roller ring, roller ring
12 rolling body
13 inner wall of inner rolling ring 10
14 middle axis of trunnion 7
15 outer wall of outer roller ring 11
16 rotational axis of outer joint part 2
17a, 17b bearing collar of outer roller ring 11
18a, 18b relief
19a, 19b inner collar section
20a, 20b outer collar section
21a, 21b retaining ring
22a, 22b end-face wall of outer roller ring 11
23 outer raceway of inner rolling ring 10
24 inner raceway of outer roller ring 11
25 outer wall of rolling body 12
Ra surface roughness
S_{R} radial play

What is claimed is:

1-10. (canceled)

11. A constant-velocity tripod joint comprising:
an outer joint part having a central cavity and three recesses extending out from the central cavity and uniformly distributed around the inner periphery, each having two axially parallel slideways disposed in mutual parallel opposition around the inner periphery;
an inner joint part within the central cavity having three trunnions having a spherical outer contour uniformly distributed around the inner periphery, each extending radially into one of the recesses of the outer joint part;
three tripod rollers, each having an inner roller ring, an outer roller ring, and a plurality of cylindrical rolling bodies disposed annularly between the inner and outer roller rings; the respective inner roller rings being disposed, in each case by the inner wall thereof, in sliding contact with the outer contour of the associated trunnion; and the respective outer roller rings being disposed, in each case by the outer wall thereof, in sliding contact with the slideways of the associated recess, and
a surface treatment on the outer contour, the inner wall, the slideways and the outer wall to improve frictional and wear properties of the constant-velocity joint.

12. The constant-velocity tripod joint as recited in claim 11 wherein at least one of the inner roller rings, the outer roller rings and retaining rings for axially securing the inner or outer roller rings are provided with an anti-friction coating, the anti-friction coating defining the surface treatment.

13. The constant-velocity tripod joint as recited in claim 12 wherein the anti-friction coating is applied by a coating-forming phosphating treatment.

14. The constant-velocity tripod joint as recited in claim 13 wherein the anti-friction coating is in the form of a manganese phosphate coating having a thickness of 2 to 6 μm.

15. The constant-velocity tripod joint as recited in claim 11 wherein the inner roller rings, at least at the inner and end-face walls thereof, and/or the outer roller rings, at least at the outer walls thereof, and/or the retaining rings at least at the inner walls thereof facing the end-face walls of the inner roller rings, undergo slide grinding.

16. The constant-velocity tripod joint as recited in claim 15 wherein a surface roughness of the inner and end-face walls of the inner roller rings and/or of the inner walls of retaining rings is reduced to a value of approximately Ra=0.2 μm.

17. The constant-velocity tripod joint as recited in claim 15 wherein a surface roughness of the outer walls of the outer roller rings is reduced to a value of approximately Ra=0.45 μm.

18. The constant-velocity tripod joint as recited in claim 11 wherein a rolling resistance between the roller rings and the rolling bodies of the tripod rollers is reduced in each case by providing a finish-ground surface for an outer raceway of the inner roller ring, for an inner raceway of the outer roller ring, and for the outer wall of the rolling bodies, as well as by reducing radial play between the roller rings and the rolling bodies.

19. The constant-velocity tripod joint as recited in claim 18 wherein a surface roughness of the outer raceway of the inner roller ring, of the inner raceway of the outer roller ring, and of the outer wall of the rolling bodies is reduced in each case to a value within the range of between Ra=0.2 μm and Ra=0.45 μm.

20. The constant-velocity tripod joint as recited in claim 18 wherein the radial play between the roller rings and the rolling bodies is reduced in each case to a value within the range of between s_{R}=0.008 mm and s_{R}=0.030 mm.
